(19) United States
(12) Patent Application Publication
(10) Pub. No.: US 2009/0299847 A1
(43) Pub. Date: Dec. 3, 2009

(54) System for Multi-Tiered Allocation of Promotional Incentives

(76) Inventors: Jodi Keeter, Alpharetta, GA (US); David Barber, Hixson, TN (US); Donna Jeffrey, Soddy Daisy, TN (US); Brad Smrcina, Cleveland, TN (US); Shane Painter, Chattanooga, TN (US)

Correspondence Address: LUEDEKA, NEELY & GRAHAM, P.C., P O BOX 1871, KNOXVILLE, TN, 37901, US

(21) Appl. No.: 12/435,190

(22) Filed: May 4, 2009

Related U.S. Application Data
(60) Provisional application No. 61/050,053, filed on May 2, 2008.

(51) Int. Cl. G06Q 30/00; G06F 3/048

(52) U.S. Cl. 705/14.35; 705/14.1; 715/743

(57) ABSTRACT

An interactive promotion platform for supplying a call center agent with promotional incentive information to provide to a customer. The interactive promotion platform includes a promotion database having a promotional incentive index into which a promoting entity inputs one or more promotional incentives for inclusion in the promotional incentive index. A promotion allocation dashboard displays to an allocator the promotional incentive index and enables the allocator to designate at least one promotional incentive from in the promotional incentive index and allocate the designated promotional incentive to one or more call center agents. A computer network including a network link connects the call center agent to the interactive promotion platform and provides substantially real time updated information on the designated promotional incentive to the call center agent.

### PRIORITY

This application claims priority to provisional patent application No. 61/050,053 filed May 2, 2008, under 35 U.S.C. § 119(e).

### FIELD

This invention relates to a sales promotional tool which provides improved and easy access to promotional incentives by call center agents. More particularly, this invention relates to an interactive promotion platform for enabling a promoting entity to allocate promotional incentives to chosen call center agents who can then provide the incentives to a customer.

### BACKGROUND

Many businesses use centralized offices, often referred to as call centers, for processing a large volume of requests by phone. A call center typically includes a large workspace including a multitude of call center agents, with each agent working at a separate work station with a telephone often connected to a computer network. Such call centers may handle customer service, technical support, billing issues, and inbound and outbound sales calls, for example. Many businesses employ agents to call their customers to offer them special discounts or to promote various goods or services. For example, a cable service provider may have agents call customers to offer them a free or discounted period of a cable service, after which the customer may choose to continue the service at a certain cost. Other businesses may have agents call former customers to offer them incentives if they return as customers. Additionally, agents may handle inbound calls from customers requesting new or different goods, services, or service/product upgrades.

Call center agents may be provided a list of promotional offers or incentives available from a business. Such offers or incentives may be created by a marketing team to target certain products or services or meet certain business's goals. Such promotional offers or incentives have often been mass marketed by the businesses to consumers (customers and potential customers), for example, via print, television, radio, and/or internet advertising. The promotional offers or incentives may also have been offered to customers or potential customers by targeted advertising, such as by delivery of an email, postcard or other device to a particular group of customers or potential customers, although the particular promotional offer is often available to anyone who requests the offer or incentive. Consumers may respond to the advertising by calling in to the call center to sign up for the particular offer or an agent may call a consumer regarding a promotional offer. Additionally, call center agents often handle calls from consumers interested in non-promotional goods or services. In these circumstances, call center agents are provided an opportunity to “upsell” the consumer by offering promotional offers or incentives such as add-on goods or services in addition to the requested goods and services or alternative goods and services which provide a better long term profit potential for the business. In some call centers, agents are provided commissions or other incentives based on their ability to upsell customers or potential customers.

Call centers and promotional offers or incentives provide opportunities to increase closure rates of sales, upsell certain products, cross sell add-on products, or sell various product packages; all resulting in increased revenues for businesses. Accordingly, there is a need for an offer platform which provides improved and easy access to promotional incentives by call center agents and management. Additionally, there is a need for promotional offer opportunities which will maximize the revenue potential of the call center and the business.

### SUMMARY

The above and other needs are met by an interactive promotion platform for supplying a call center agent with promotional incentive information to provide to a customer. The interactive promotion platform includes a promotion database having a promotional incentive index into which a promoting entity inputs one or more promotional incentives for inclusion in the promotional incentive index. A promotion allocation dashboard displays to an allocator the promotional incentive index and allows the allocator to select at least one promotional incentive from the list of promotions and allocate the designated promotional incentive to one or more call center agents. A computer network having a network link is included for connecting the call agent to the interactive promotion platform and for providing substantially real time updated information on the designated promotional incentive to the call center agent. The substantially real time updated information may include the number of designated promotional incentives the call center agent has remaining to offer to customers or the time remaining the call center agent has to offer the designated promotional incentive.

In some embodiments of the invention, the interactive promotion may include a manager allocation dashboard for enabling the allocator to allocate the designated promotional incentive to one or more call center managers who allocate the designated promotional incentive to the call center agents. The interactive promotion platform may also include an agent allocation dashboard for enabling the allocator or the call center managers to allocate the designated promotional incentive to the call center agents. The promoting entity may establish an authority level for the allocator or the call center managers for determining whether the allocator or the call center managers has access to the manager allocation dashboard, the agent allocation dashboard, or both. A report menu may be provided with the promotion allocation dashboard for aiding the allocator in their selection of the designated promotional incentive or for aiding the allocator in, their selection of which call center agent to allocate the designated promotional incentive to.

In another embodiment, the promotion allocation dashboard includes the manager allocation dashboard and the agent allocation dashboard and the allocator includes a manager allocator and an agent allocator. The manager allocation dashboard enables the manager allocator to allocate the designated promotional incentive to the agent allocator and the agent allocation dashboard displays to the agent allocator the designated promotional incentive and enables the agent allocator to allocate the designated promotional incentive to the one or more call center agents. The manager allocator may have access to both the manager allocation dashboard and the agent allocation dashboard for enabling the manager allocator to allocate the designated promotional incentive to either the agent allocator or directly to the one or more call center agents.

A third party fulfillment vendor may set up or manage the interactive promotion platform for the promoting entity. In this embodiment of the invention, the fulfillment vendor may input the one or more promotional incentives into the promotion database for the promoting entity. The interactive promotion platform may also include a promotion acceptance verification dashboard managed by the third party fulfillment vendor. The verification dashboard may allow a customer accepting the designated promotional incentive from the call center agent to redeem the promotional incentive.

In another aspect, embodiments of the invention provide a method for providing a call center agent with promotional incentive information to provide to a customer. The method includes the steps of storing one or more promotional incentives in a promotion database having a promotional incentive index into which a promoting entity inputs one or more of the promotional incentives for inclusion in the promotional incentive index; displaying the promotional incentive index to an allocator on a promotion allocation dashboard, the promotion allocation dashboard for enabling the allocator to designate at least one promotional incentive in the promotional incentive index to be allocated to one or more call center agents; connecting the one or more call center agents to an agent incentive dashboard using a computer network having a network link; and displaying to the one or more call center agents on the agent incentive dashboard in substantially real time updated information on the designated promotional incentive. The substantially real time updated information may include the number of designated promotional incentives the call center agent has remaining to offer to customers.

In embodiments where the promotion allocation dashboard includes the manager allocation dashboard and the agent allocation dashboard and the allocator includes a manager allocator, the method may include enabling the promoting entity to establish an authority level for the manager allocator for determining whether the manager allocator has access to the manager allocation dashboard, the agent allocation dashboard, or both.

The method may also include processing the designated promotional incentive after a customer has accepted the promotional incentive. The processing may be handled by a third party fulfillment vendor and it includes the third party fulfillment vendor verifying with the promoting entity that the customer is eligible to redeem the promotional incentive and fulfilling the promotional incentive if the customer is eligible to redeem the incentive.

In yet another aspect, embodiments of the invention provide a method for providing a call center agent with promotional incentive information including the steps of inputting one or more promotional incentives from a promotion database for inclusion in a promotional incentive index; designating from a promotional allocation dashboard displaying the promotional incentive index at least one promotional incentive from the promotional incentive index to be allocated to one or more call center agents; and allocating the designated promotional incentive from the promotion allocation dashboard to one or more call center agents, the call center agents being connected to an agent incentive dashboard using a computer network having a network link, and the agent incentive dashboard for providing substantially real time updated information including the number of designated promotional incentives the call center agent has remaining to offer to the customer to the call center agent. Where the promotion allocation dashboard includes a manager allocation dashboard and an agent allocation dashboard, the method may also include allocating the designated promotional incentive from the manager allocation dashboard to one or more call center managers who allocate the incentive from the agent allocation dashboard to the call center agents and establishing an authority level for at least one of the call center mangers for determining whether the call center manager has access to the manager allocation dashboard, the agent allocation dashboard, or both.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 depicts a flowchart describing a process for allocating promotional incentives to call center agents.

FIG. 2 is a view of a promotion allocation dashboard according to an embodiment of the present invention;

FIG. 3 is a view of a distribution report accessible from the promotion allocation dashboard of FIG. 2 according to one embodiment of the present invention;

FIG. 4 is a view of a usage report accessible from the promotion allocation dashboard of FIG. 2 according to one embodiment of the present invention;

FIG. 5 is a view of a manager allocation dashboard according to an embodiment of the present invention;

FIG. 6 is a view of an agent allocation dashboard according to an embodiment of the present invention;

FIG. 7 is a view of a promotion acceptance dashboard according to an embodiment of the present invention;

FIG. 8 is a view of a sample postcard sent to a customer giving the customer notice that they may be eligible for a reward;

FIG. 9 is a view of a customer reward center login page according to an embodiment of the present invention;

FIG. 10 is a view of customer reward center redemption page according to an embodiment of the present invention; and

FIG. 11 is a view of reward center status page according to an embodiment of the present invention.

### DEFINITIONS

The following list of definitions is provided to facilitate understanding and meaning of some of the terms as used herein.

Promoting Entity: Any type of business or entity that offers promotional incentives to consumers who purchase, upgrade, or use the business's goods or services.

Third Party Fulfillment Vendor: Any business or entity separate and distinct from the promoting entity. The third party fulfillment vendor may be hired to perform various services for the promoting entity including, for example, to manage and process the offering and rewarding of promotional incentives for the promoting entity.

Call Center Agent: Any person who handles incoming and outgoing customer calls for the promoting entity. The call center agent may be an employee of the promoting entity or may be an employee of a third party fulfillment vendor hired by the promoting entity for the purpose of handling its customer calls.

Call Center Manager: Any person who has superior authority, directs, or oversees the call center agents.

Promotional Incentive: A promotional incentive is any type of reward that may be offered to attempt to persuade a customer or potential customer to purchase goods or services of the promoting entity. Types of promotional incentives may include, for example, gift cards, free or discounted service, or other free or discounted products.

Promotion Database: A database containing one or more promotional incentives.

Promotional Incentive Index: A list of promotions that the promoting entity has designated from promotion database to be allocated to call center agents.

Interactive Promotion Platform: Any type of system having a computer network connecting a series of interfaces that allow agents and management of the promoting entity or authorized third parties to access or interact with the system for the ultimate purpose of offering promotional incentives to customers.

Dashboard: Any type of interface for accessing the interactive promotion platform such as, for example, a standard web interface. Dashboards of the interactive promotion platform include a promotion allocation dashboard, a manager allocation dashboard, an agent allocation dashboard, and a promotion acceptance dashboard.

Allocator: Any person who has the ability to allocate promotional incentives to another hierarchal level of the promotion platform or to another member of the sales call team. For example, an allocator may allocate promotional incentives to a call center manager or a call center agent. An allocator that allocates promotional incentives to a call center manager may also be referred to as a manager allocator. The call center manager may also be an allocator who may allocate promotional incentives to a call center agent or other call center managers. An allocator that allocates promotional incentives to a call center agent may also be referred to as an agent allocator.

### DETAILED DESCRIPTION

A preferred embodiment of the present invention comprises an interactive promotion platform which is engagable in various aspects by a promoting business or any other promoting entity, call center management, and call center agents. The call center management and agents may be employees of the promoting entity or the call center may be a third party hired by the promoting entity. The promoting entity, call center management, and call center agents are preferably connected to the promotion platform via one or more computer networks having a network link for providing substantially real time updated information to all platform users. The promotion platform may be accessed by computer via a standard web interface, such as a personal computer including a CPU, monitor, keyboard, and mouse, or various other interfaces connected to the computer network. The promotion platform provides members of a call center sales team with tools needed to make a sale, while also providing the promoting entity with its desired level of control over the sales process.

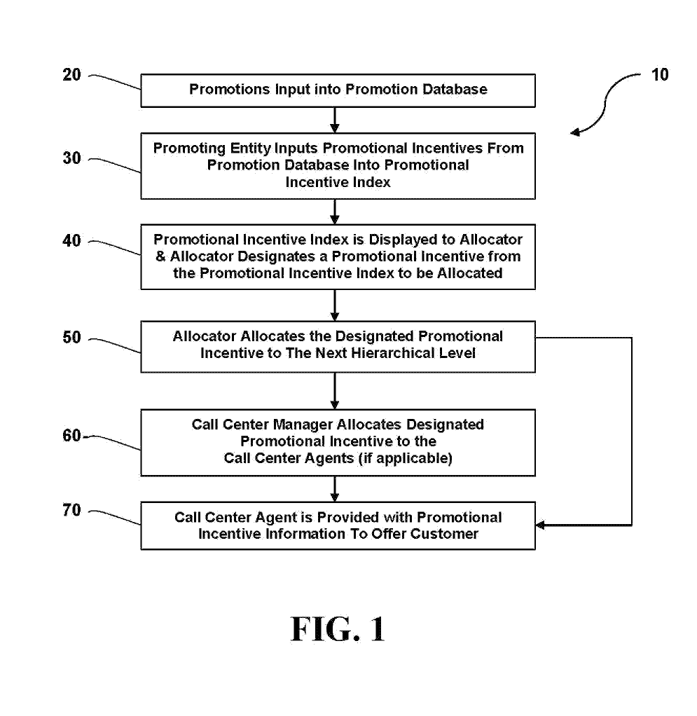

As shown in FIG. 1, during set up of the promotion platform 10, a promoting entity or a third party entity must first create promotional offers or incentives to be input into a promotion database 20. In addition to inputting promotions into the database during setup of the promotion platform 10, promotions may be input into the database 20 on a continuing basis after setup. The promotion database may also include a promotional incentive index 30 or list of promotional incentives that the promoting entity has designated from the promotion database 20 be allocated to call center agents.

In one embodiment, one or more promotions may be input into the database 20 by the entity offering the promotions. Various promotion terms and conditions are input into the database 20. Examples of such terms and conditions include the promotion name, any internal promotion codes, the start date and end date, if any, of the availability of the promotion, and the promotion description. The promotion description may include a certain product or service at a reduced price. In other embodiments, the description may include a reward for a customer purchasing a certain product or service. For example, the promotion may provide a gift card to a customer who purchases a certain product or service. In further embodiments, the description includes a particular product or service which must be purchased to obtain a second product or service at a reduced price or for free. The promotion description may also include qualification requirements. For example, a consumer may be required to maintain an ordered service without cancellation for a certain period of time to receive a reward or a reduced price.

In a preferred embodiment of the invention, the input terms and conditions may also include a number of offers which are available. For example, the promoting entity may allocate a limited number of gift cards available for use by call center agents. As explained further below, this creates the novel ability for call center agents to make limited time offers, leading to increased impulse purchases by consumers.

In addition to the promoting entity inputting offers into a database 20, in alternate embodiments, the promotions may be input into the database 20 by a designated third party, such as a fulfillment vendor. The promoting entity may then choose which incentives from the promotion database 20 to include in the promotional incentive index 30. In certain embodiments, a fulfillment vendor may be used to manage the processing and fulfillment of rewards to customers. In such an embodiment, the promoting entity may choose an item from the promotion database 30 or the fulfillment vendor's inventory to offer as a reward, such as a gift card, and provide the vendor with terms and conditions for offering the reward or incentive in a promotion. The fulfillment vendor may then input the terms and conditions into the database 20.

After promotions have been input into the promotional incentive index 30, the promotions may be made available for use by call center agents. In certain embodiments, promotions are made available through the promotion platform 10 for use by all call center agents. However, in these or other embodiments, some other promotions may only be available to a portion of the call center agents and/or the agents may only be allocated a limited number of rewards to offer customers.

In a preferred embodiment, the promoting entity may set hierarchical levels of authority to allocate promotions. From a promotion allocation dashboard 40, an allocator for the promoting entity is able to select or designate from the promotional incentive index 30 a designated promotional incentive. The allocator will then be able to allocate the designated promotional incentive either directly to call center agents or the allocator may allocate promotions to call center managers who may then allocate promotions to call center agents. In some embodiments, the allocator will be able to allocate the designated promotional incentive from the promotion allocation dashboard 40. In other embodiments, the allocator (also referred to as a manager allocator) may allocate the designated promotional incentive to call center managers from a manager allocation dashboard 50. However, if the allocator is given the proper authority from the promoting entity, the allocator may also allocate the designated promotional incentive to a call center agent. If the designated promotional incentive is allocated to a call center manager, an agent allocation dashboard 60 is available for enabling the call center manager (also referred to as an agent allocator) to allocate the designated promotional incentive to various call center agents. In further embodiments, a call center may have multiple levels of management where each level may allocate promotions to the next lower level or any other level that they have been given authority to allocate promotional incentives.

Once the designated promotional incentive has been allocated to a call center agent, the call center agent has access to an agent incentive dashboard 70 for displaying to the call center agent the designated promotional incentive and the appropriate promotional incentive information to offer to the customer.

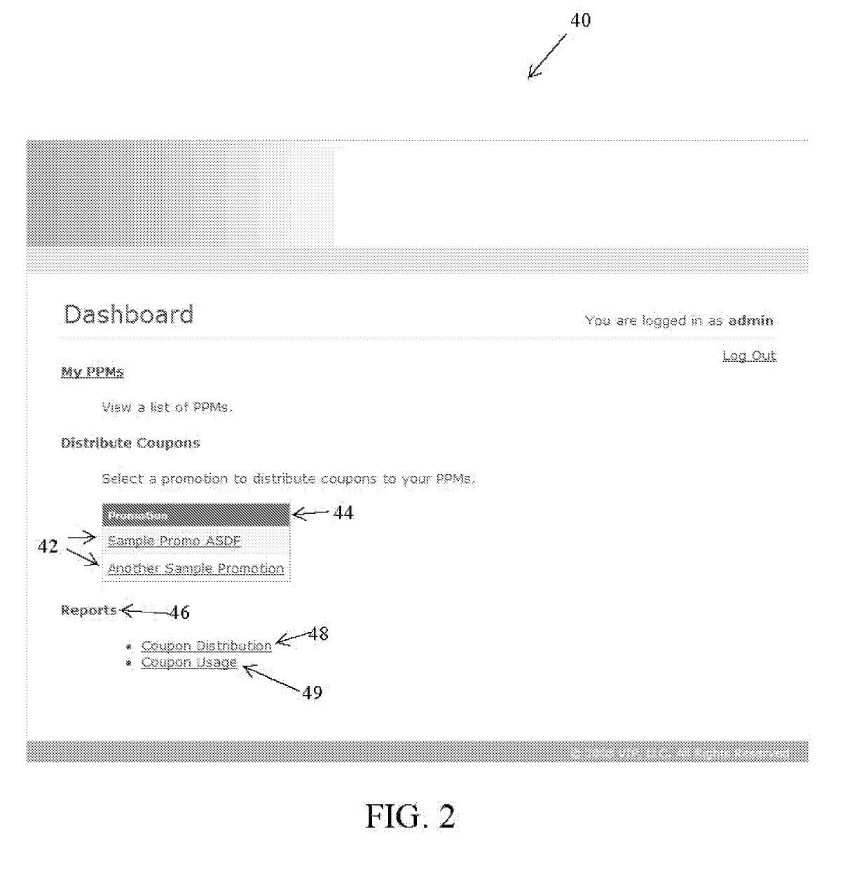

A preferred embodiment of the method of allocating promotions in the promotion platform among the hierarchal levels and examples of the accompanying dashboards of the interactive promotion platform is shown in FIGS. 2-6. FIG. 2 shows a view of a promotion allocation dashboard 40 according to an embodiment of the invention. In this illustrative embodiment, the promotion platform displays a promotion allocation dashboard 40 to an allocator from which the allocator may select a promotion 42 from a promotion menu 44 that includes the promotional incentives in the promotional incentive index for allocation among the next hierarchal level. For example, a promoting entity may choose a certain number of reward gift cards to be directly or indirectly distributed to call center agents for offering to customers in a limited promotion. The promoting entity may choose the applicable promotion 42, such as “Sample Promo ASDF,” from the promotion menu 44.

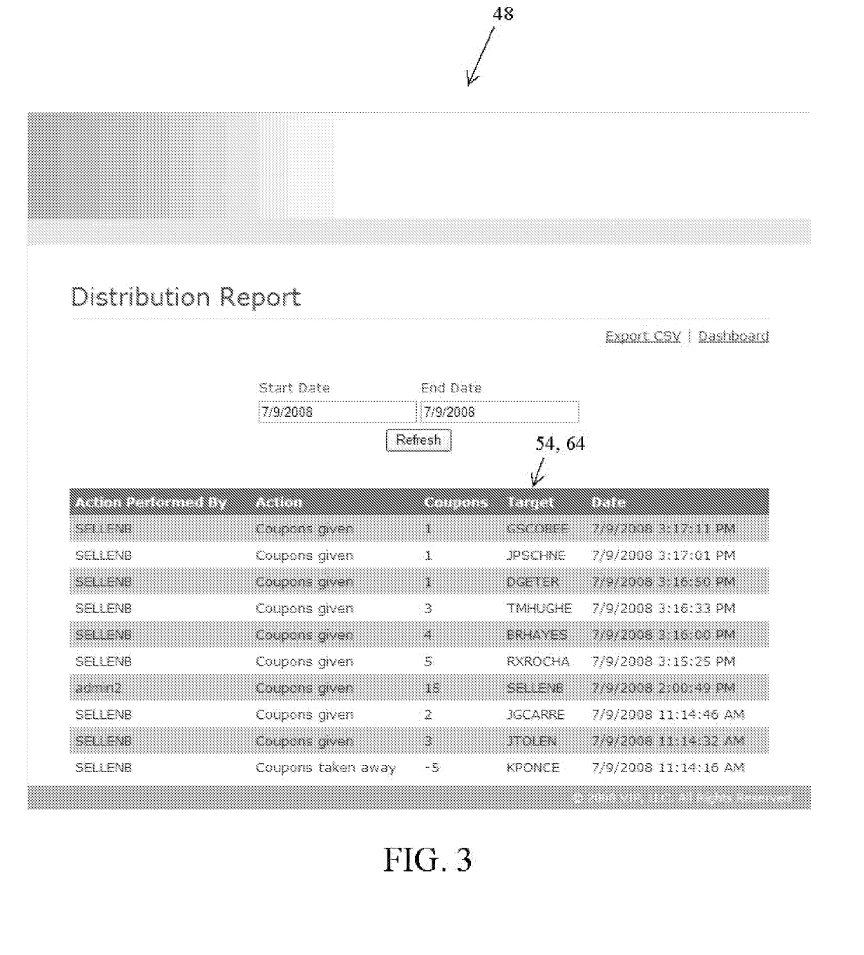

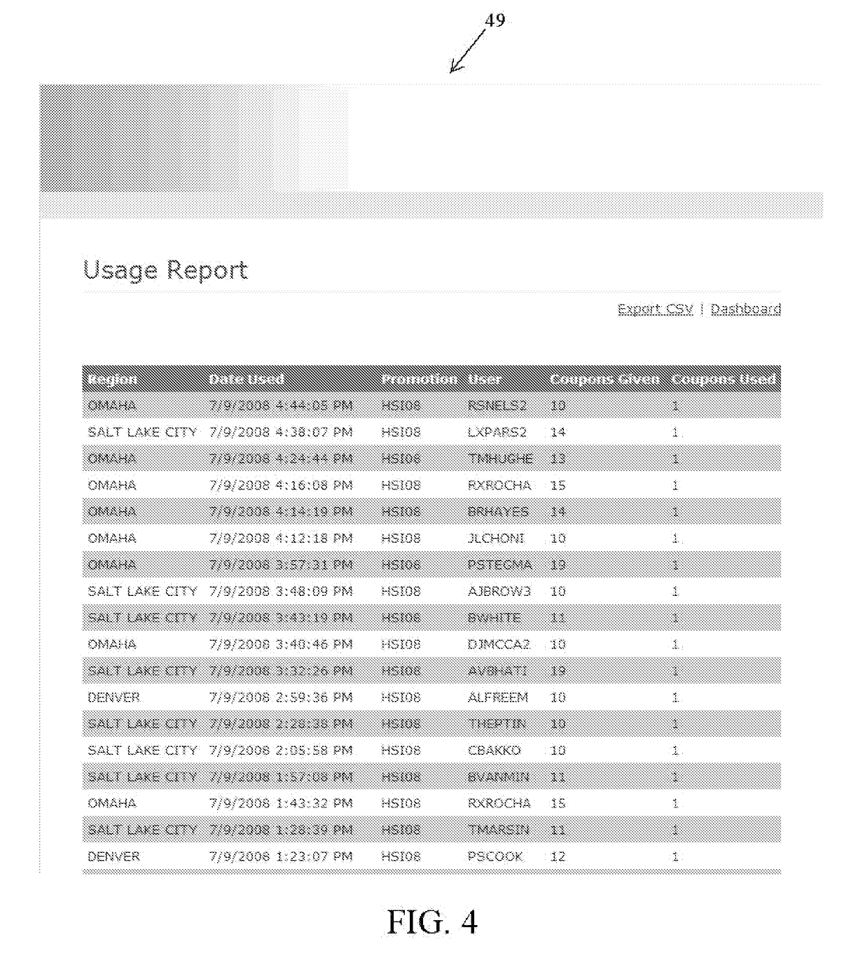

Various reports may be accessible from an optional report menu 46 within the promotion allocation dashboard 40 to help the allocator in their selection of a particular promotion 42 from the promotional menu 44 and in their rationing of rewards among call center agents or managers. As shown in FIG. 2, the allocator may select from the report menu 46 to view a distribution report 48 or a usage report 49. The distribution report 48, as shown in FIG. 3, may be selected to display to the allocator the number of coupons (e.g., reward gift cards) that have been allocated or taken away from various call center agents or managers 54, 64 within a date range. As shown in FIG. 4, the usage report 49 may be selected to display to the allocator the number of coupons allocated to call center agents or managers and the number of coupons they have used. Thus, the allocator may view the reports and determine which call center managers and agents should be allocated coupons based on their activity shown in the various reports and/or which promotions 42 have been more successful. However, it should be understood that the types of reports available in the report menu 46 can vary and may include statistical summaries, graphs, charts, etc. Furthermore, the report menu 46 is not limited to the promotion allocation dashboard 40. It may be included on any of the other dashboards of the promotion platform described below as desired.

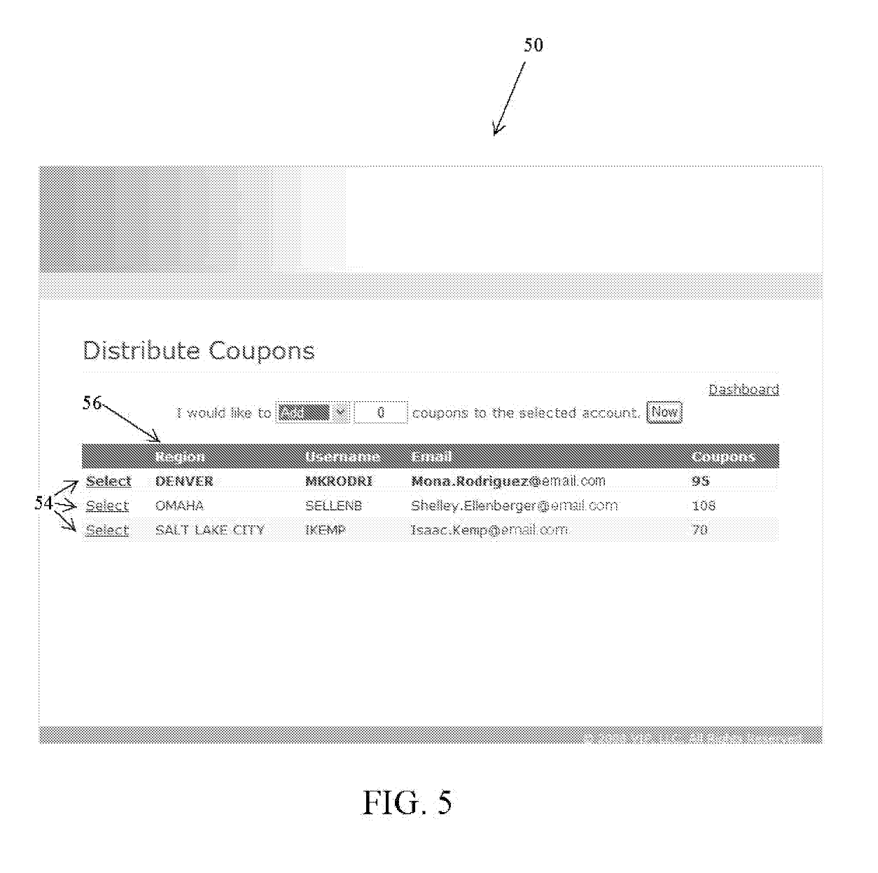

When the applicable promotion is selected, the promotion platform may then display a manager allocation dashboard 50 to the allocator for allocating coupons offered under the selected promotion 42 to the next hierarchical level, FIG. 5 shows a manager allocation dashboard 50 wherein a promoting entity may allocate coupons to call center managers 54 in various regions. From the manager allocation dashboard 50, the manager allocator may select a particular call center manager 54, and then add or remove the number of coupons available for the chosen call center manager 54 to be able to disperse to their call center agents. The call center manager information is listed in a call center manager menu 56. The call center manager information may include various information regarding each of the call center managers 54 such as the name or user identification for the managers, the managers' email addresses, the number of gift cards currently available to the call center managers, and any other appropriate information.

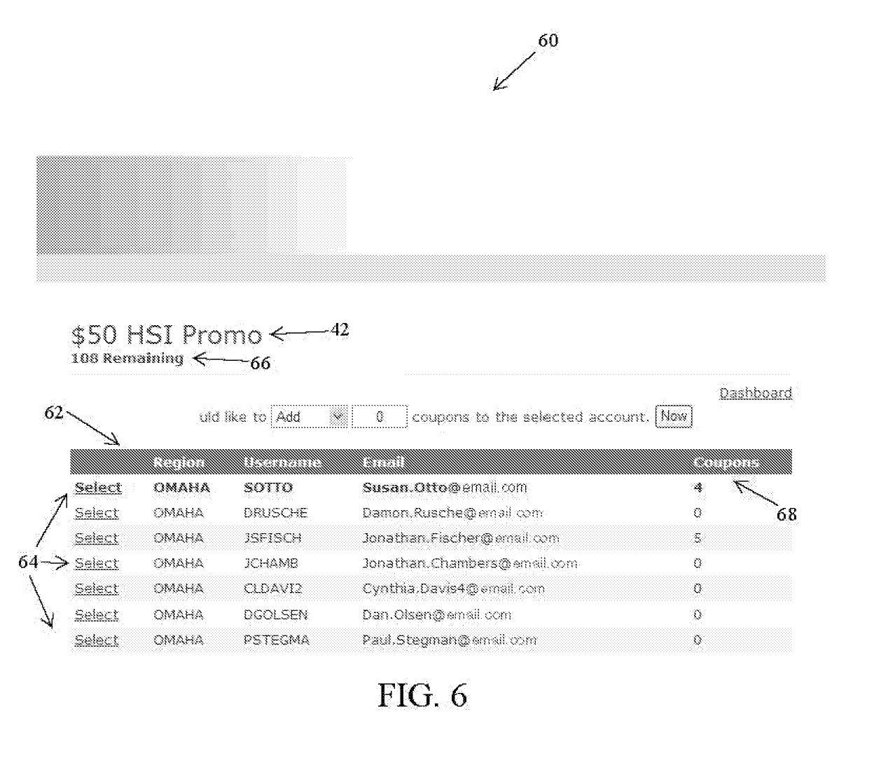

FIG. 6 shows an agent allocation dashboard 60 of a preferred embodiment. From the agent allocation dashboard 60, a call center manager of a particular call center or group of call center agents, an agent allocator, or other authorized individual with access to the agent allocation dashboard 60, is shown a call center agent menu 62 containing a list of call center agents 64 for distribution of coupons and information for each agent. The agent allocation dashboard 60 may display the number of remaining coupons 66 for the promotion 42 available to the call center manager 54, and the call center agent information may include the number of coupons 68 already allocated to each call center agent 64. The call center manager 54 or other authorized individual may then add or remove coupons available for the call center agents 64 to offer as incentives to customers.

In various other embodiments of the invention, the interactive promotion platform may be used to provide the promoting entity with a variety of options available to allocate the promotions. For example, an allocator, after being given appropriate authority or access from the promoting entity, may use the manager allocation dashboard 50 or agent allocation dashboard 60 to designate certain call center managers or agents as having the ability to offer promotions which are unlimited as to quantity. In another example, an allocator for the promoting entity may have the option to transfer promotions 42 from one entity representative to another depending upon the promoting entity's criteria. The promoting entity may also limit access of managers 54, agents 64, management, or other employees to the promotion platform. For example, the promoting entity may limit access of managers 54 only to the agent allocation dashboard 60, or the promoting entity may choose to give access to managers 54 to the manager allocation dashboard 50 and the agent allocation dashboard 60. In other words, the promoting entity may decide which employees have access to particular hierarchical levels of the promotion platform. Also, each particular dashboard may include any features of the other dashboards as desired. For example, the promotion allocation dashboard 40 may include the features of both the manager allocation dashboard 50 and the agent allocation dashboard 60 so that the allocator may choose a promotional incentive from the report menu 44 and allocate designated promotional incentives to call center managers 54, call center agents 64, or both from the same dashboard.

Furthermore, the promoting entity may choose to offer a wide variety of individualized promotions 42, with or without any larger mass promotions, to certain regions, managers, or even certain agents within one call center. Thus, the promoting entity may choose to provide call center agents 64 with a wide variety of promotions to offer, but some of the promotions may be different than what another call center agent 64 has the ability to offer. Therefore, certain call center agents 64 may have the ability to offer certain promotions that another agent within the same region does not have the ability to offer. The limited number of incentives available to certain agents and the lack of access to such incentives by other agents leads to more impulse buying because the customer will be unable to know whether they will ever have the chance to receive the same promotional offer if they do not accept the promotion immediately during a discussion with a call center agent.

The method of offering promotional incentives to customers will now be described in further detail. Call center agents receive and/or initiate telephone discussions with customers and/or potential customers regarding a promoting entity's products. During the discussions, the call center agents 64 have access to an interactive promotion platform via an agent incentive dashboard (not shown) on their computer desktop. The agent incentive dashboard displays the promotions 42 available to the call center agent 64 during the sales process. The display may include information specific to each call center agent 64 such as the types of promotions 42 available to the agent to offer to the customer, the number of each type of promotion 42 the agent has available, and the terms and conditions of each type of promotion 42. When the call center agent 64 determines that the customer may be receptive to an incentive to purchase the promoting entity's goods and services, the agent 64 is able to quickly access the interactive promotion platform via the agent incentive dashboard and offer one of the agent's 64 allocated promotions 42 to the customer. Because the call center agent 64 has immediate access to the number of allocated promotions 42 available to the agent and/or the duration of the particular promotion 42, which information may be provided to the customer, the call center agents 64 have the ability to make limited time offers. Thus, depending on the number of promotions 42 left to offer and/or the expiration of the promotion 42, in a preferred embodiment, the situation created will also lead to more impulse buying by the consumer.

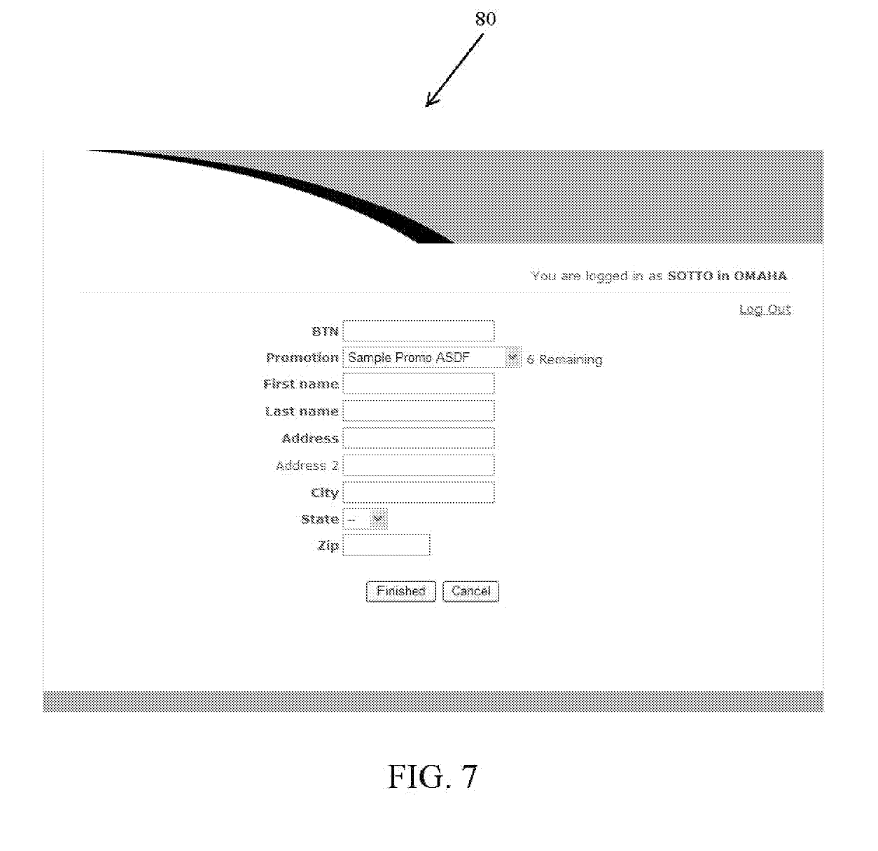

A preferred embodiment of the method of processing accepted promotions to customers as an incentive to purchase the promoting entity's product is shown in FIGS. 7-11. In this embodiment, as mentioned above, a third party fulfillment vendor may be used to manage the processing and fulfillment of rewards to consumers. In a preferred embodiment, the third party fulfillment vendor is the same entity that initially sets up the interactive promotion platform for the promoting entity. The use of a fulfillment vendor allows for the management of the promotion platform and processing of rewards to take place in a centralized location remote from the promoting entity, leading to lower costs and greater flexibility of options for the promoting entity. The fulfillment vendor may also provide the call center services or may be independent of the call center. However, it should be understood that the promoting entity may perform the method if it chooses to have its own incentive managing department handle the processing and fulfillment of the rewards itself. Additionally, in some embodiments, such as where the promoting entity's goods or services are offered at a reduced price or for free, rather than where a reward if provided to the customer, a fulfillment vendor may be unnecessary. In such an embodiment, the promoting entity may provide the good or service to the customer according to its standard practice, but at a reduced billing rate.

As shown in FIG. 7, if a customer accepts a promotion 42 offered by a call center agent, the call center agent 64 may obtain information from the customer and enters the customer information, such as the customer's name, address, and billing telephone number, and the applicable promotion 42 into a promotion acceptance dashboard 80 that preferably automatically enters the data into the fulfillment vendor's database for the fulfillment vendor's access. In certain embodiments, the promotion acceptance dashboard 80 may be integrated with or accessible through the agent allocation dashboard 60.

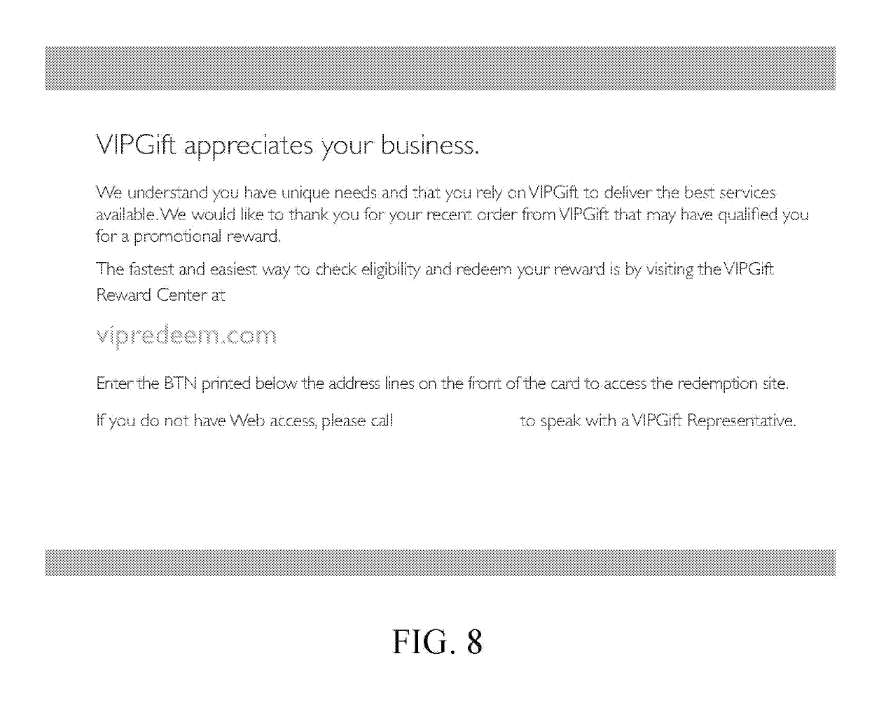

After the fulfillment vendor receives the customer and promotion information, the vendor may then take action to provide the customer with the incentive offered by the promoting entity via the call center agent 64. In some embodiments, the fulfillment vendor may deliver the incentive, such as a gift card, to the customer upon receipt of the customer and promotion information. However, in a preferred embodiment, the fulfillment vendor will take various steps prior to fulfilling the promotion. In such an embodiment, the fulfillment vendor may mail a postcard, send an email, or give some other type of notice (as shown in FIG. 8) to each customer in the fulfillment vendor database. In a preferred embodiment, the notice will preferably include verbiage that the customer may be eligible to receive an incentive. The notice may instruct the customer to go to the fulfillment vendor hosted website to verify, redeem, and/or finalize the promotional offer or to take some other redemption/verification step, such as to return a postcard with additional customer information, return a sales receipt, or some other appropriate verification step.

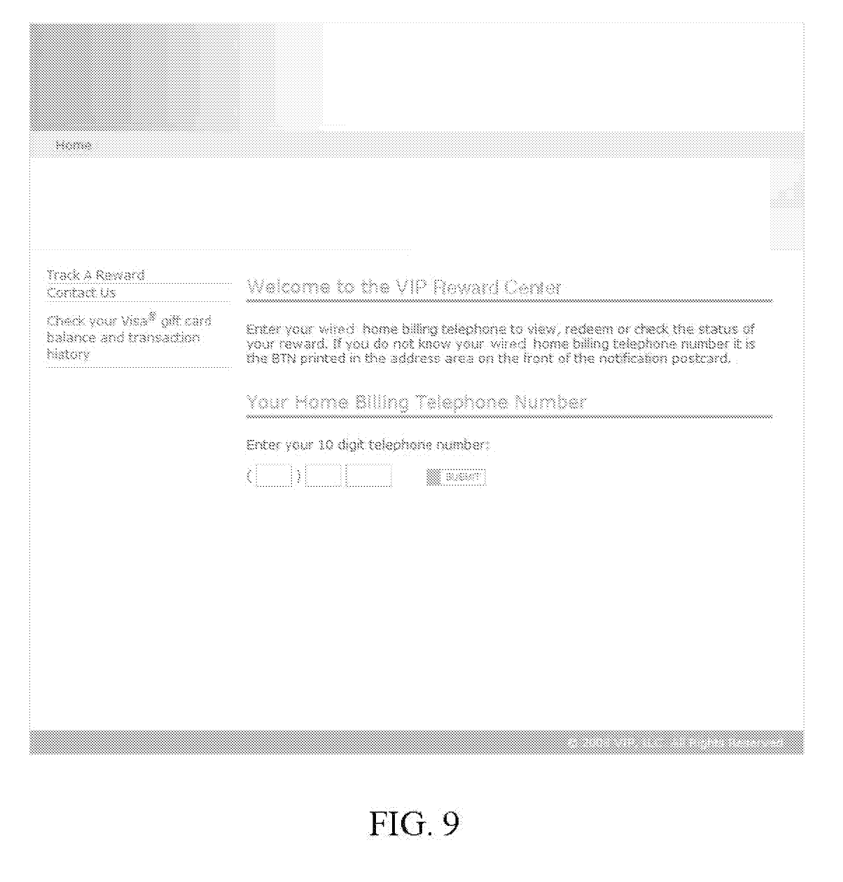

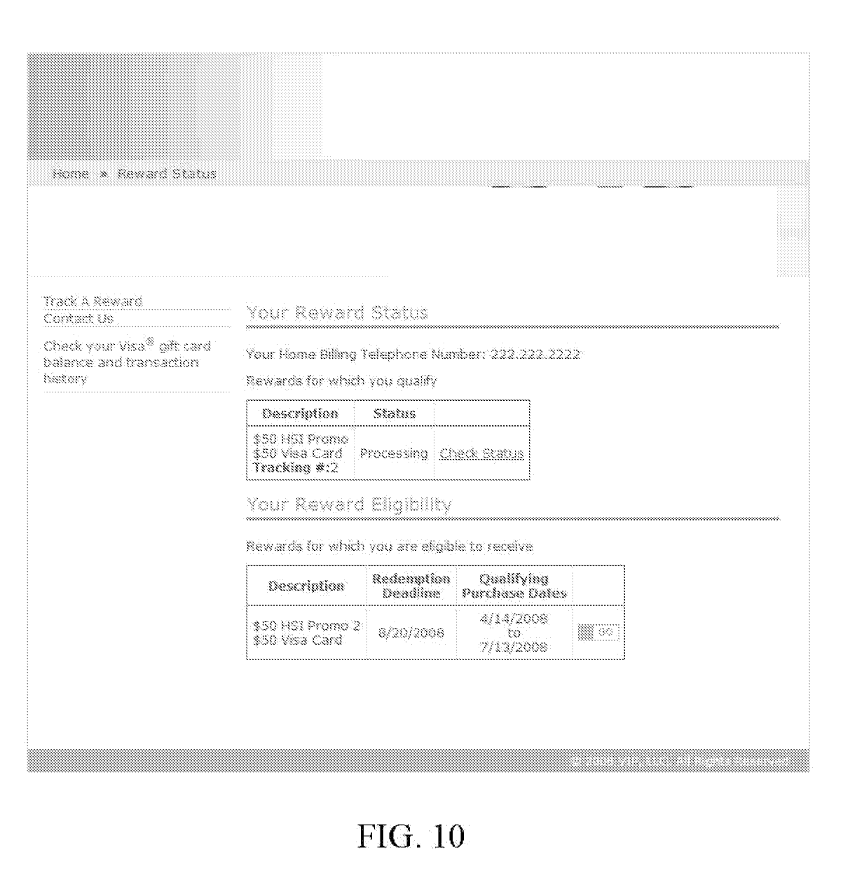

In a preferred embodiment, as shown in FIG. 9, when the customer goes to the fulfillment vendor website to redeem the promotion 42, the customer may be able to log in using their billing telephone number or other customer information such as their email address, name, etc. The customer is then given a list of rewards for which they may be eligible (FIG. 10). The list of rewards may be a single item, such as a specific gift card or the list may include a plurality of available items such as prepaid debit cards, catalog items, vacation packages, movie tickets and merchant gift cards. The customer can choose one or more rewards from the list to receive.

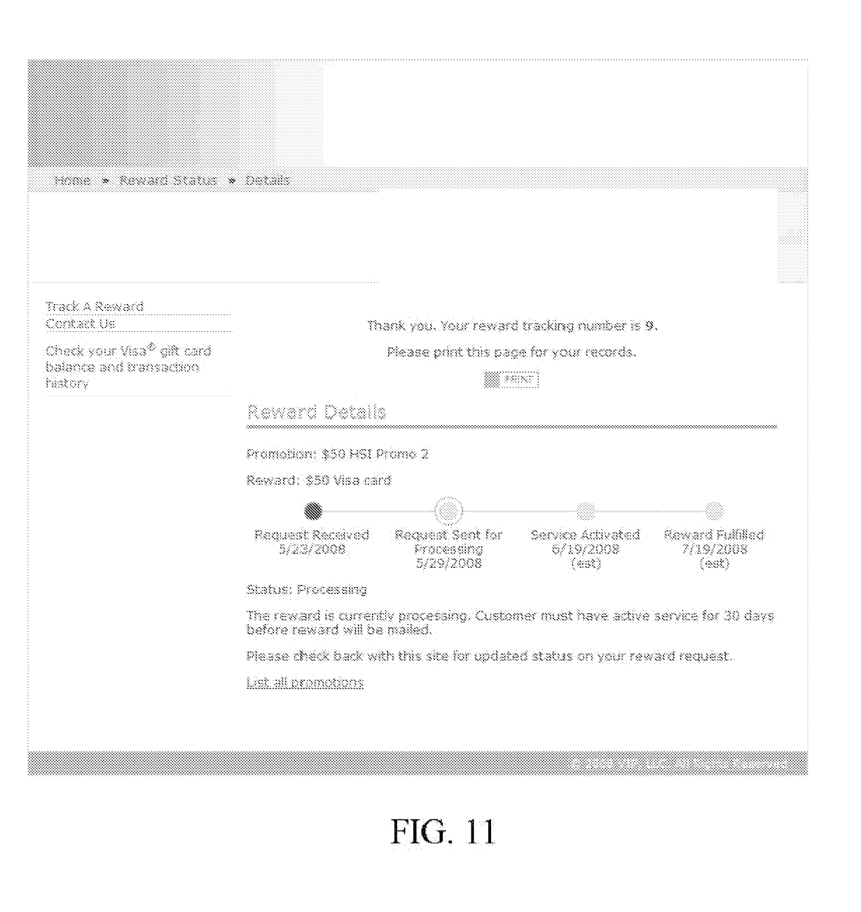

In certain embodiments, the fulfillment vendor may deliver the reward to the customer after the customer chooses a reward. However, in a preferred embodiment, after the customer chooses a reward or at another appropriate time in the process, customer information, such as the name of the customer, is transmitted in a secured, electronic file back to the promoting entity. The promoting entity may then verify whether the customer included in the electronic file is eligible to receive the reward based on the customer's purchase of the promoting entity's good and services. For example, in certain promotions, the promoting entity may require that their customer maintain the client's service for a set period of time before the customer will receive the reward. The promoting entity may wait for the set period of time to expire to see if the customer maintained service for the required period of time. The promoting entity may then send a file back to the fulfillment vendor of all customers who are eligible to receive the rewards and a list of those customers who are not eligible. If the customer does not meet the promoting entity's eligibility criteria, the customer may receive a postcard or other notice from the fulfillment vendor indicating that they are not eligible to receive the reward. If the customer is eligible to receive the reward, the fulfillment vendor will finish the processing stage by fulfilling the incentive, which is usually done by mailing the reward to the customer. As shown in FIG. 11, customers may have the ability to access the fulfillment vendor website to check the status of their reward in real-time.

The foregoing description of preferred embodiments for this invention has been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally, and equitably entitled.

What is claimed is:

1. An interactive promotion platform for providing a call center agent with promotional incentive information to provide to a customer, the interactive promotion platform comprising:
a promotion database having a promotional incentive index into which a promoting entity inputs one or more promotional incentives for inclusion in the promotional incentive index;
a promotion allocation dashboard for displaying to an allocator the promotional incentive index and for enabling the allocator to designate at least one promotional incentive in the promotional incentive index and allocate the designated promotional incentive to one or more call center agents; and
a computer network including a network link for connecting the call center agent to the interactive promotion platform and for providing substantially real time updated information on the designated promotional incentive to the call center agent.

2. The interactive promotion platform of claim 1 wherein the substantially real time updated information includes the number of designated promotional incentives the call center agent has remaining to offer to customers.

3. The interactive promotion platform of claim 1 wherein the designated promotional incentive includes an expiration time and the substantially real time updated information includes the time remaining the call center agent has to offer the designated promotional incentive.

4. The interactive promotion platform of claim 1 wherein the allocator allocates the designated promotional incentive to one or more call center managers who allocate the designated promotional incentive to the one or more call center agents, the interactive promotion platform further comprising a manager allocation dashboard for enabling the allocator to allocate the designated promotional incentive to the one or more call center managers.

5. The interactive promotion platform of claim 4 further comprising an agent allocation dashboard for enabling the allocator or the call center managers to allocate the designated promotional incentive to the one or more call center agents.

6. The interactive promotion platform of claim 5 wherein the promoting entity establishes an authority level for the allocator, the authority level for determining whether the allocator has access to the manager allocation dashboard, the agent allocation dashboard, or both.

7. The interactive promotion platform of claim 1 wherein the promotion allocation dashboard includes a manager allocation dashboard and an agent allocation dashboard and the allocator includes a manager allocator and an agent allocator, the manager allocation dashboard for enabling the manager allocator to allocate the designated promotional incentive to the agent allocator, and the agent allocation dashboard for displaying to the agent allocator the designated promotional incentive and for enabling the agent allocator to allocate the designated promotional incentive to the one or more call center agents.

8. The interactive promotion platform of claim 7 wherein the manager allocator has access to both the manager allocation dashboard and the agent allocation dashboard for enabling the manager allocator to allocate the designated promotion incentive to either the agent allocator or directly to the one or more call center agents.

9. The interactive promotion platform of claim 1 wherein a third party fulfillment vendor sets up or manages the interactive promotion platform for the promoting entity.

10. The interactive promotion platform of claim 9 wherein the fulfillment vendor inputs the one or more promotional incentives into the promotion database for the promoting entity.

11. The interactive promotion platform of claim 9 further comprising a promotion acceptance verification dashboard managed by the third party fulfillment vendor, the verification dashboard for enabling a customer accepting the designated promotional incentive from the call center agent to redeem the promotional incentive.

12. The interactive promotion platform of claim 1 wherein the promotion allocation dashboard includes a report menu which provides for aiding the allocator in their selection of the designated promotional incentive from the promotional incentive index or for aiding the allocator in their selection of the one or more call center agents to allocate the designated promotional incentive to.

13. A method for providing a call center agent with promotional incentive information to provide to a customer, the method comprising the steps of:
storing one or more promotional incentives in a promotion database having a promotional incentive index into which a promoting entity inputs one or more of the promotional incentives for inclusion in the promotional incentive index;
displaying the promotional incentive index to an allocator on a promotion allocation dashboard, the promotion allocation dashboard for enabling the allocator to designate at least one promotional incentive in the promotional incentive index to be allocated to one or more call center agents;
connecting the one or more call center agents to an agent incentive dashboard using a computer network having a network link; and
displaying to the one or more call center agents on the agent incentive dashboard in substantially real time updated information on the designated promotional incentive.

14. The method of claim 13 wherein the substantially real time updated information includes the number of designated promotional incentives the call center agent has remaining to offer to customers.

15. The method of claim 13 wherein the promotion allocation dashboard includes a manager allocation dashboard and an agent allocation dashboard and the allocator includes a manager allocator and an agent allocator, the manager allocation dashboard for enabling the manager allocator to allocate the designated promotional incentive to the agent allocator, and the agent allocation dashboard for displaying to the agent allocator the designated promotional incentive and for enabling the agent allocator to allocate the designated promotional incentive to the one or more call center agents.

16. The method of claim 15 further comprising enabling the promoting entity to establish an authority level for the manager allocator, the authority level for determining whether the manager allocator has access to the manager allocation dashboard, the agent allocation dashboard, or both.

17. The method of claim 13 further comprising processing the designated promotional incentive after a customer has accepted the promotional incentive, the processing being handled by a third party fulfillment vendor.

18. The method of claim 16 wherein the processing includes the third party fulfillment vendor verifying with the promoting entity that the customer is eligible to redeem the promotional incentive and the third party fulfillment vendor fulfilling the promotional incentive if the customer is eligible to redeem the promotional incentive.

19. A method for providing a call center agent with promotional incentive information to provide to a customer, the method comprising the steps of:
inputting one or more promotional incentives from a promotion database for inclusion in a promotional incentive index;
designating from a promotional allocation dashboard displaying the promotional incentive index at least one promotional incentive from the promotional incentive index to be allocated to one or more call center agents; and
allocating the designated promotional incentive from the promotion allocation dashboard to one or more call center agents, the call center agents being connected to an agent incentive dashboard using a computer network having a network link, and the agent incentive dashboard for providing substantially real time updated information including the number of designated promotional incentives the call center agent has remaining to offer to the customer to the call center agent.

20. The method of claim 19 wherein the promotion allocation dashboard includes a manager allocation dashboard and an agent allocation dashboard, the method further comprising:
allocating the designated promotional incentive from the manager allocation dashboard to one or more call center managers who allocate the designated promotional incentive from the agent allocation dashboard to the one or more call center agents; and
establishing an authority level for at least one of the call center managers, the authority level for determining whether the call center manager has access to the manager allocation dashboard, the agent allocation dashboard, or both.
